(19) United States
(12) Patent Application Publication
(10) Pub. No.: US 2011/0156969 A1
(43) Pub. Date: Jun. 30, 2011

(54) Printed Antenna

(75) Inventors: Tsung-Wen Chiu, Taipei (TW); Fu Ren Hsiao, Taipei County (TW)

(73) Assignee: ADVANCED CONNECTEK INC., Taipei County (TW)

(21) Appl. No.: 12/773,697

(22) Filed: May 4, 2010

(30) Foreign Application Priority Data
Dec. 25, 2009 (TW) 098144905

(51) Int. Cl. H01Q 1/38; H01Q 1/00

(52) U.S. Cl. 343/720; 343/700 MS

(57) ABSTRACT

A printed antenna comprises an ink-printed layer, a hard substrate and a radiation conductor layer. The hard substrate has a surface, and the ink-printed layer is coated on the surface to form a non-transparent area. The uncoated region of the surface is a transparent area. The radiation conductor layer is formed on the ink-printed layer and does not exceed the non-transparent area of the hard substrate. In the present invention, a conductive ink is coated on the surface of a non-metallic plate, such as a glass plate, an acrylic plate or an LCD panel, to form the radiation conductor layer. Therefore, the printed antenna of the present invention is exempt from the complicated processes of fabricating the conventional metallic radiation conductors with the application field thereof expanded.

### BACKGROUND OF THE INVENTION

1. Field of the Invention

The present invention relates to a printed antenna, particularly to an antenna using a conductive ink as the material of the radiation conductor.

2. Description of the Related Art

With the progress of information science and technology, the portable computer has evolved from a simple business machine for word processing and financial computing to a multimedia device functioning as TV, a game machine, a CD/DVD player, and an IP phone. Many functions of the current portable computer depend on the internet access capability. With the popularization of wireless communication, the portable computer also becomes a multi-antenna environment, including the systems of Wi-Fi, WLAN, GSM and other wireless communication standards.

The current portable computer usually adopts metals and a microwave medium circuit board as the materials of the antenna module. According to the desired operation frequency band, the researchers design an appropriate shape of the radiation conductor to attain the required resonant frequency. The portable computer is usually equipped with at least three or four antenna modules to meet the requirement of users. Thus, a metallic radiation conductor usually has a complicated form, including angles, 3D deflections, curves, etc., which should need longer fabrication time, increase the material cost and raise the fraction defective.

### SUMMARY OF THE INVENTION

One objective of the present invention is to provide a printed antenna, which uses a conductive ink as the material of the radiation conductor, wherein the conductive ink is coated on a non-metallic plate, such as a glass plate, an acrylic plate or an LCD panel, to directly form a radiation conductor, whereby the present invention is exempt from the numerous complicated processes of fabricating the conventional metallic conductor, and whereby the present invention has a wider application field.

Another objective of the present invention is to provide a printed antenna, which uses a conductive ink as the material of the radiation conductor, wherein the conductive ink can be easily and precisely fabricated into various radiation conductor structures, such as irregular curves, arcs, deflections, etc., with high radiation efficiency and superior radiation patterns being attained simultaneously.

A further objective of the present invention is to provide a printed antenna, wherein the shape and dimensions of the radiation conductor layer can be locally varied to achieve the desired electric parameters, whereby the printed antenna can cooperate with various system chips, and whereby the performance of the antenna printed on the hard substrate can be optimized to increase the transmission distance and signal stability.

To achieve the abovementioned objectives, the present invention proposes a printed antenna, which comprises an ink-printed layer, a hard substrate and a radiation conductor layer. The surface of the hard substrate is divided into a transparent area and a non-transparent area. The ink-printed layer is coated on the non-transparent area. The conductive radiation conductor layer is formed on the ink-printed layer and doses not exceed the non-transparent area of the hard substrate.

The radiation conductor layer is primarily made of a conductive ink. In fabricating the printed antenna, a viscous adhesive black ink is coated on the non-transparent area of a flat smooth surface of a non-metallic plate, such as a glass plate, an acrylic plate or an LCD panel, to form the ink-printed layer. Then, a conductive ink is coated on the ink-printed layer to form the radiation conductor layer. The black ink of the ink-printed layer is very adhesive and able to stick the radiation conductor layer tightly onto a smooth surface, such as the surface of an LCD panel. The printed antenna of the present invention can replace the conventional antenna, which is formed of a metallic radiation conductor and a microwave medium circuit board. Because the printed antenna of the present invention is exempt from the complicated processes of fabricating the conventional metallic radiator plate, the yield rate thereof is promoted. The conductive ink can easily form various patterns of the radiation conductor layer, no matter an arc, a curve, an angle or a bend, with high radiation transmission efficiency and superior radiation patterns achieved simultaneously. The shape and dimensions of the radiation conductor layer can be easily varied to attain the desired electric parameters and optimize the performance of the antenna printed on the hard substrate, whereby is greatly increased the transmission distance and signal stability.

Below, the embodiments are described in detail to make easily understood the technical contents if the present invention.

### BRIEF DESCRIPTION OF THE DRAWINGS

FIG. 1 is a perspective exploded view schematically showing a printed antenna according to a first embodiment of the present invention;

FIG. 2 is a perspective assembly drawing schematically showing a printed antenna according to the first embodiment of the present invention;

FIG. 3 is a sectional view along Line A-A in FIG. 2;

FIG. 4 is a perspective view schematically showing that the printed antenna of the first embodiment is integrated with a portable computer; and

FIG. 5 is a perspective assembly drawing schematically showing a printed antenna according to a second embodiment of the present invention.

### DETAILED DESCRIPTION OF THE INVENTION

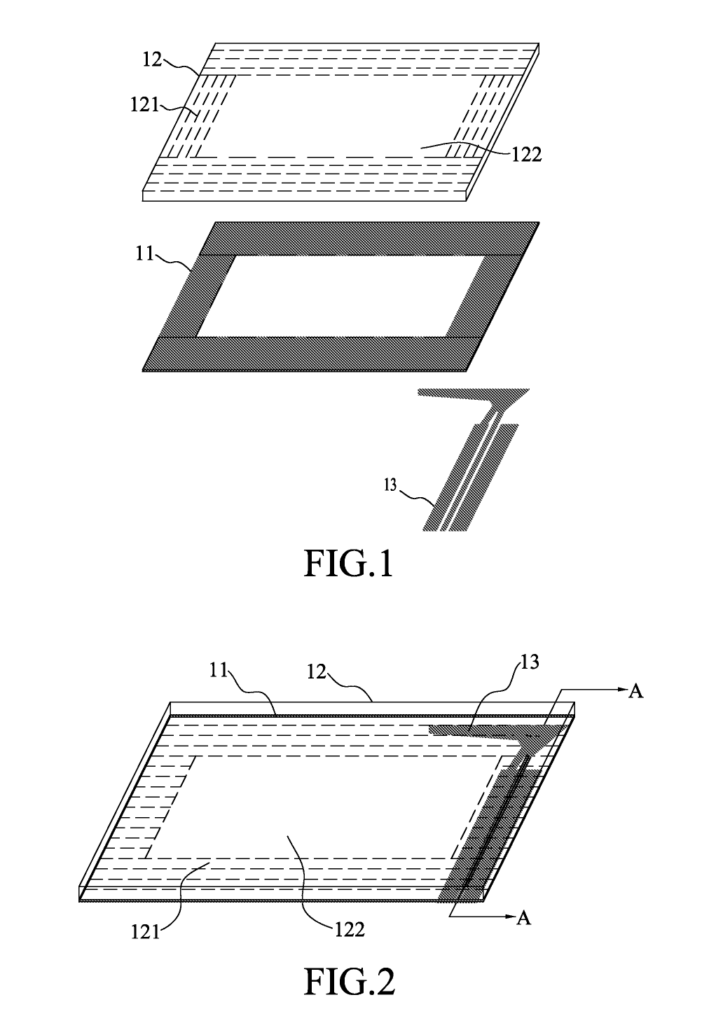

Refer to FIG. 1 and FIG. 2 respectively a perspective exploded view and a perspective assembly drawing schematically showing a printed antenna according to a first embodiment of the present invention. The printed antenna of the present invention comprises an ink-printed layer 11, a hard substrate 12 and a radiation conductor layer 13. The surface of the hard substrate 12 includes a non-transparent area 121 and a transparent area 122, and the non-transparent area 121 surrounds the transparent area 122.

In fabricating the printed antenna of the present invention, a high-viscosity black ink is uniformly coated on the non-transparent area 121 to form the ink-printed layer 11 encircling the hard substrate 12. The hard substrate 12 is a non-metallic transparent plate, such as a glass plate, an acrylic plate or an LCD panel. Thus, the transparent area 122 of the hard substrate 12 can function as the display screen of an electronic device. Next, a conductive ink is coated on the ink-printed layer 11 according to the designed pattern to form the radiation conductor layer 13. Neither the ink-printed layer 11 nor the radiation conductor layer 13 exceeds the non-transparent area 121 of the hard substrate 12.

In the first embodiment, the hard substrate 12 is a 14-in rectangular LCD panel with a length of about 220 mm and a width of about 150 mm. The ink-printed layer 11 is a hollow rectangle with an external length of about 220 mm, an external width of about 150 mm, an inner length of about 180 mm and an inner width of about 110 mm. The top of the radiation conductor layer 13 has a trapezoid-like shape with a top base of about 40 mm, a bottom base of about 10 mm and a height of about 15 mm. Two grounding members are arranged at two sides of the radiation conductor layer 13, and each of the grounding members has a rectangular shape with a long side of about 130 mm and a short side of about 10 mm. A feeder cable is arranged between the two grounding members and has a rectangular shape with a height of about 135 mm and a width of about 7 mm. A short-circuit member connects with the top trapezoid and the grounding member and has a rectangle-like shape with a long side of about 10 mm and a short side of about 6 mm.

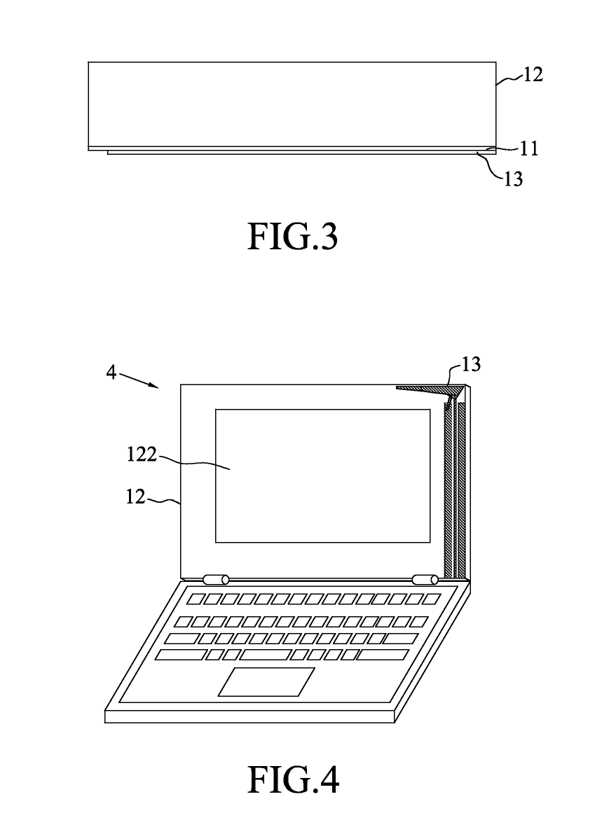

Refer to FIG. 3 a sectional view along Line A-A in FIG. 2. As shown in FIG. 3, the printed antenna of the present invention has the hard substrate 12, the ink-printed layer 11 and the radiation conductor layer 13 sequentially from top to bottom. The ink-printed layer 11 and the radiation conductor layer 13 are normally printed on the lower surface of the hard substrate 12 lest the ink-printed layer 11 and the radiation conductor layer 13 interfere with the vision of the display screen on the transparent area 122. If the ink-printed layer 11 and the radiation conductor layer 13 are printed on the upper surface of the hard substrate 12, the radiation conductor layer 13 is exposed and likely to be damaged, which may degrade the transmission efficiency and signal quality of the antenna module.

Refer to FIG. 4 a perspective view schematically showing that the printed antenna of the first embodiment is integrated with a portable computer. When the hard substrate 12 is the LCD panel of a portable computer 4, the ink-printed layer 11 and the radiation conductor layer 13 are sequentially formed on the lower surface of the LCD panel and do not intrude in the transparent area 122. Thus, the ink-printed layer 11 and the radiation conductor layer 13 would not affect the size of the transparent area 122 that presents images to users. On the other hand, the LCD panel does not hinder the radiation conductor layer 13 from transceiving signals.

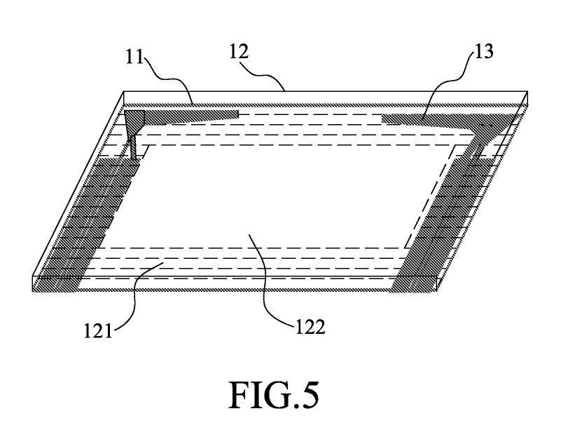

Refer to FIG. 5 a perspective assembly drawing schematically showing a printed antenna according to a second embodiment of the present invention. The second embodiment is basically similar to the first embodiment except two radiation conductor layers 13 are respectively printed on two sections of the non-transparent area 121 in the second embodiment. Such a design meets the situation that a portable computer usually has more than three or four sets of antennae. In such a design, the signals of different antennae do not interfere with each other. Further, the present invention can print all the antenna modules in a single process.

The present invention possesses utility, novelty and non-obviousness and meets the condition for a patent. Thus, the Inventor files the application for a patent. The embodiments described above are only to exemplify the present invention but not to limit the scope of the present invention. Any equivalent modification or variation according to the spirit of the present invention is to be also included within the scope of the present invention.

What is claimed is:

1. A printed antenna comprising
an ink-printed layer;
a hard substrate having a surface, wherein said ink-printed layer is coated on said surface to form a non-transparent area, and wherein an uncoated region of said surface is a transparent area; and
a radiation conductor layer formed on said ink-printed layer without exceeding said non-transparent area of said hard substrate.

2. The printed antenna according to claim 1, wherein said ink-printed layer is made of a viscous adhesive black ink.

3. The printed antenna according to claim 1, wherein said hard substrate is made of a non-metallic material.

4. The printed antenna according to claim 1, wherein said hard substrate is a glass plate, an acrylic plate or an LCD (Liquid Crystal Display) panel.

5. The printed antenna according to claim 1, wherein said hard substrate is a flat, smooth and transparent plate.

6. The printed antenna according to claim 1, wherein said transparent area is a region where a display screen is formed.

7. The printed antenna according to claim 1, wherein said radiation conductor layer is made of a conductive ink.

8. The printed antenna according to claim 1, wherein neither said ink-printed layer nor said radiation conductor layer exceeds said non-transparent area of said hard substrate.
